(19) United States
(12) Patent Application Publication
(10) Pub. No.: US 2025/0004347 A1
(43) Pub. Date: Jan. 2, 2025

(54) ELECTRO-OPTICAL ELEMENT, LIGHT SOURCE MODULE, OPTICAL ENGINE, AND XR GLASSES

(71) Applicant: TDK CORPORATION, Tokyo (JP)

(72) Inventors: Hiroki HARA, Tokyo (JP); Yasuhiro TAKAGI, Tokyo (JP)

(73) Assignee: TDK CORPORATION, Tokyo (JP)

(21) Appl. No.: 18/756,651

(22) Filed: Jun. 27, 2024

(30) Foreign Application Priority Data
Jun. 30, 2023 (JP) 2023-108108

(51) Int. Cl. G02F 1/21; G02F 1/03; G02F 1/035; G02F 1/225

(52) U.S. Cl. CPC G02F 1/212; G02F 1/0311; G02F 1/035; G02F 1/217; G02F 1/2257

(57) ABSTRACT

An electro-optical element of the present disclosure includes a substrate, and an optical function layer. The optical function layer has a light input port, an optical branching part in which a light input side optical waveguide guiding visible light input through the light input port is connected to the one optical waveguide for monitoring and two optical modulation optical waveguides, a Mach-Zehnder optical modulation part configured to modulate visible light guided by the two optical modulation optical waveguides, a 2×1 type optical coupling part configured to couple two beams of visible light modulated by the Mach-Zehnder optical modulation part, a light output side waveguide configured to guide light coupled by the optical coupling part to a light output port, the light output port, and a monitoring light output port.

### CROSS-REFERENCE TO RELATED APPLICATION

Priority is claimed on Japanese Patent Application No. 2023-108108, filed Jun. 30, 2023, the content of which is incorporated herein by reference.

### BACKGROUND OF THE INVENTION

### Field of the Invention

The present disclosure relates to an electro-optical element, a light source module, an optical engine, and XR glasses.

### Description of Related Art

Currently, glasses-type terminals are being studied in XR technologies such as virtual reality (VR) and augmented reality (AR). Particularly, in recent years, retinal scanning displays allowing a user to visually recognize images by forming images of light used for two-dimensional scanning on the user's retina have attracted attention. In retinal scanning displays, generally, three-color visible light emitted from light sources such as light emitting diodes (LEDs) or laser diodes (LDs) respectively corresponding to colors of R (red), G (green), and B (blue) are coupled on one optical axis. The coupled three-color visible light are transmitted to an image display part. The image display part performs two-dimensional scanning of transmitted light and causes it to be incident on the user's pupil. An image of this incident light is formed on the user's retina so that the user visually recognizes the image. In this case, the retina serves as a screen displaying images.

Patent Document 1 discloses a signal generation unit of an image display device provided with a photodetection unit that detects an amount of remaining light, of emission light from a light source to an optical fiber, which is not incident on the optical fiber.

### PATENT DOCUMENT

[Patent Document 1] Japanese Patent No. 6728596

### SUMMARY OF THE INVENTION

The constitution disclosed in Patent Document 1 requires an optical fiber between a light source and an optical modulator.

In a planar lightwave circuit (PLC) having a light source such as a laser diode (LD) mounted thereon, temperature dependence of the light source becomes a problem. Fluctuation in amount of emission light occurs due to fluctuation in amount of light caused by the temperature of the LD. For this reason, there is a need to cause monitoring light to branch from a main waveguide, to feed back the fluctuation in amount of the monitoring light to a control unit, and to control a current applied to the LD.

In addition, LN modulators in communication have problems with a DC drift and a temperature drift, and from the viewpoint of long-term reliability, there is a need to monitor fluctuation in operation point and to feed back the result to a DC control unit. For this reason, in Mach-Zehnder optical modulators, there is a need to cause light which has passed through an interaction portion in which an electrode for applying an electric field to a waveguide is formed to branch into two and monitor modulated light. For this reason, for example, there is a constitution in which modulated light is caused to branch into two using a 2×2 type multimode interferometer (MMI) such that it is divided into monitoring light and output light. At this time, there is a problem that output light becomes ½ of input light at most.

Since XR glasses are used for a short period of time, influences of a DC drift and a temperature drift of lithium niobate (LN (LiNbO₃)) are sufficiently small so that there is no need to consider them. Therefore, only the temperature dependence of an LD need be able to be monitored. The inventor has conceived of a constitution in which input light branches into three, electrodes constituting a Mach-Zehnder optical modulator are provided for two branched beams, and the remaining one branched ray is output as monitoring light. In this constitution, output light can be ⅔ of input light at most.

The present disclosure has been made in consideration of the foregoing circumstances, and an object thereof is to provide an electro-optical element, a light source module, an optical engine, and XR glasses, in which degradation in efficiency of an intensity of output light with respect to an intensity of input light can be curbed while input light is monitored.

In order to resolve the foregoing problems, the present disclosure provides the following means.

Aspect 1 of the present disclosure is an electro-optical element including a substrate, and an optical function layer configured to be formed on a main surface of the substrate. The optical function layer has a light input port configured to allow visible light emitted from a visible laser light source to be input therethrough, an optical branching part in which a light input side optical waveguide guiding visible light input through the light input port is connected to one optical waveguide for monitoring and a plurality of optical modulation optical waveguides, a Mach-Zehnder optical modulation part configured to modulate visible light guided by the plurality of optical modulation optical waveguides, an optical coupling part configured to couple two beams of visible light modulated by the Mach-Zehnder optical modulation part, a light output side waveguide configured to guide light coupled by the optical coupling part to a light output port, the light output port through which light guided by the light output side waveguide is output to the outside, and a monitoring light output port through which light guided by the optical waveguide for monitoring is output toward a photodetector.

According to Aspect 2 of the present disclosure, in the electro-optical element according to Aspect 1, the plurality of optical modulation optical waveguides are two optical modulation optical waveguides.

According to Aspect 3 of the present disclosure, in the electro-optical element according to Aspect 1 or 2, the substrate is made of a material different from lithium niobate, and the optical function layer is made of lithium niobate.

According to Aspect 4 of the present disclosure, in the electro-optical element according to any one of Aspects 1 to 3, both the optical branching part and the optical coupling part constitute a multimode interferometer.

According to Aspect 5 of the present disclosure, the electro-optical element according to any one of Aspects 1 to 4 further includes three light input ports configured to allow three beams of visible light having different wavelengths and respectively output from three visible laser light sources to be input therethrough, and three light output ports configured to output three beams of visible light having different wavelengths to the outside.

According to Aspect 6 of the present disclosure, the electro-optical element according to any one of Aspects 1 to 4 further includes three light input ports configured to allow three beams of visible light having different wavelengths and respectively output from three visible laser light sources to be input therethrough, an optical coupling part configured to couple three beams of visible light having different wavelengths, and one light output port configured to output light coupled by the optical coupling part to the outside.

According to Aspect 7 of the present disclosure, in the electro-optical element according to Aspect 1, the plurality of optical modulation optical waveguides are (N₁−1) (N₁ is an integer equal to or larger than 3) optical modulation optical waveguides. A (N₁−1)×2 type optical coupling/branching part, in which the (N₁−1) optical modulation optical waveguides are connected to an incidence side and two optical waveguides connected to the Mach-Zehnder optical modulation part are connected to an emission side, is provided between the optical branching part and the Mach-Zehnder optical modulation part.

According to Aspect 8 of the present disclosure, in the electro-optical element according to Aspect 7, the substrate is made of a material different from lithium niobate, and the optical function layer is made of lithium niobate.

According to Aspect 9 of the present disclosure, in the electro-optical element according to Aspect 7 or 8, both the optical branching part and the optical coupling part constitute a multimode interferometer. In addition, the (N₁−1)×2 type optical coupling/branching part may also constitute a multimode interferometer.

According to Aspect 10 of the present disclosure, the electro-optical element according to any one of Aspects 7 to 9 further includes three light input ports configured to allow three beams of visible light having different wavelengths and respectively output from three visible laser light sources to be input therethrough, and three light output ports configured to output three beams of visible light having different wavelengths to the outside.

According to Aspect 11 of the present disclosure, the electro-optical element according to any one of Aspects 7 to 9 further includes three light input ports configured to allow three beams of visible light having different wavelengths and respectively output from three visible laser light sources to be input therethrough, an optical coupling part configured to couple three beams of visible light having different wavelengths, and one light output port configured to output light coupled by the optical coupling part to the outside.

According to Aspect 12 of the present disclosure, in the electro-optical element according to Aspect 1, the plurality of optical modulation optical waveguides are 2N₂ (N₂ is an integer equal to or larger than 2) optical modulation optical waveguides. Two N₂×1 type optical branching parts are provided between the optical branching part and the Mach-Zehnder optical modulation part. In each of the two N₂×1 type optical branching parts, N₂ optical modulation optical waveguides of the 2N₂ optical modulation optical waveguides are connected to an incidence side, and one optical waveguide connected to the Mach-Zehnder optical modulation part is connected to an emission side.

According to Aspect 13 of the present disclosure, in the electro-optical element according to Aspect 12, the substrate is made of a material different from lithium niobate, and the optical function layer is made of lithium niobate.

According to Aspect 14 of the present disclosure, in the electro-optical element according to Aspect 12 or 13, the two N₂×1 type optical branching parts constitute a multimode interferometer. In addition, the optical branching part and the optical coupling part may also constitute a multimode interferometer.

According to Aspect 15 of the present disclosure, the electro-optical element according to any one of Aspects 12 to 14 further includes three light input ports configured to allow three beams of visible light having different wavelengths and respectively output from three visible laser light sources to be input therethrough, and three light output ports configured to output three beams of visible light having different wavelengths to the outside.

According to Aspect 16 of the present disclosure, the electro-optical element according to any one of Aspects 12 to 14 further includes three light input ports configured to allow three beams of visible light having different wavelengths and respectively output from three visible laser light sources to be input therethrough, an optical coupling part configured to couple three beams of visible light having different wavelengths, and one light output port configured to output light coupled by the optical coupling part to the outside.

According to Aspect 17 of the present disclosure is a light source module including the electro-optical element according to any one of Aspects 1 to 16, a visible laser light source configured to output visible light input through the light input port, and a laser light intensity control part configured to detect monitoring light from the monitoring light output port using a photodetector and adjust an intensity of laser light emitted from the visible laser light source in accordance with an intensity of detected light.

According to Aspect 18 of the present disclosure is an optical engine including the light source module according to Aspect 17 configured to be mounted therein.

According to Aspect 19 of the present disclosure is XR glasses including the light source module according to Aspect 17 configured to be mounted therein.

According to the present disclosure, it is possible to provide an electro-optical element in which degradation in efficiency of an intensity of output light with respect to an intensity of input light can be curbed while input light is monitored.

### BRIEF DESCRIPTION OF THE DRAWINGS

FIG. 1 is a schematic plan view showing an electro-optical element according to a first embodiment.

FIG. 2 is a schematic cross-sectional view of the electro-optical element shown in FIG. 1 cut along X-X′.

FIG. 3 is a schematic plan view showing an electro-optical element according to a second embodiment.

FIG. 4 is a schematic plan view showing an electro-optical element according to a third embodiment.

FIG. 5A is a schematic plan view showing a modification example of an electro-optical element according to the first embodiment.

FIG. 5B is a schematic plan view showing another modification example of an electro-optical element according to the first embodiment.

FIG. 6 is a schematic plan view showing a light source module according to a fourth embodiment.

FIG. 7 is a schematic plan view showing a light source module according to a fifth embodiment.

FIG. 8 is a schematic plan view showing a light source module according to a sixth embodiment.

FIG. 9A is a schematic plan view showing a modification example of a light source module according to the fourth embodiment.

FIG. 9B is a schematic plan view showing another modification example of a light source module according to the fourth embodiment.

FIG. 10 is an explanatory conceptual diagram of an optical engine and XR glasses according to the present embodiment.

FIG. 11 is a conceptual diagram showing a situation in which an image is directly projected onto the retina by laser light emitted from the light source module according to the present embodiment.

FIG. 12A is a plan view of a model of an optical branching part and an optical waveguide connected thereto subjected to a simulation of Experimental example 1.

FIG. 12B is a schematic cross-sectional view along line A-A in FIG. 12A.

FIG. 12C is a schematic cross-sectional view along line B-B in FIG. 12A.

FIG. 13A is a plan view of a model of an optical branching part and an optical waveguide connected thereto subjected to a simulation of Experimental example 2.

FIG. 13B is a schematic cross-sectional view along line A-A in FIG. 13A.

FIG. 13C is a schematic cross-sectional view along line B-B in FIG. 13A.

FIG. 14A is a plan view of a model of an optical branching part and an optical waveguide connected thereto subjected to a simulation of Experimental example 3.

FIG. 14B is a schematic cross-sectional view along line A-A in FIG. 14A.

FIG. 14C is a schematic cross-sectional view along line B-B in FIG. 14A.

### DETAILED DESCRIPTION OF THE INVENTION

Hereinafter, embodiments will be described in detail suitably with reference to the diagrams. In the drawings used in the following description, in order to make characteristics easy to understand, characteristic portions may be illustrated in an enlarged manner for the sake of convenience, and dimensional ratios or the like of each constituent element may differ from actual values thereof. Materials, dimensions, and the like illustrated in the following description are merely exemplary examples. The present disclosure is not limited thereto and can be suitably changed and performed within a range in which the effects of the present disclosure are exhibited.

### [Electro-Optical Element]

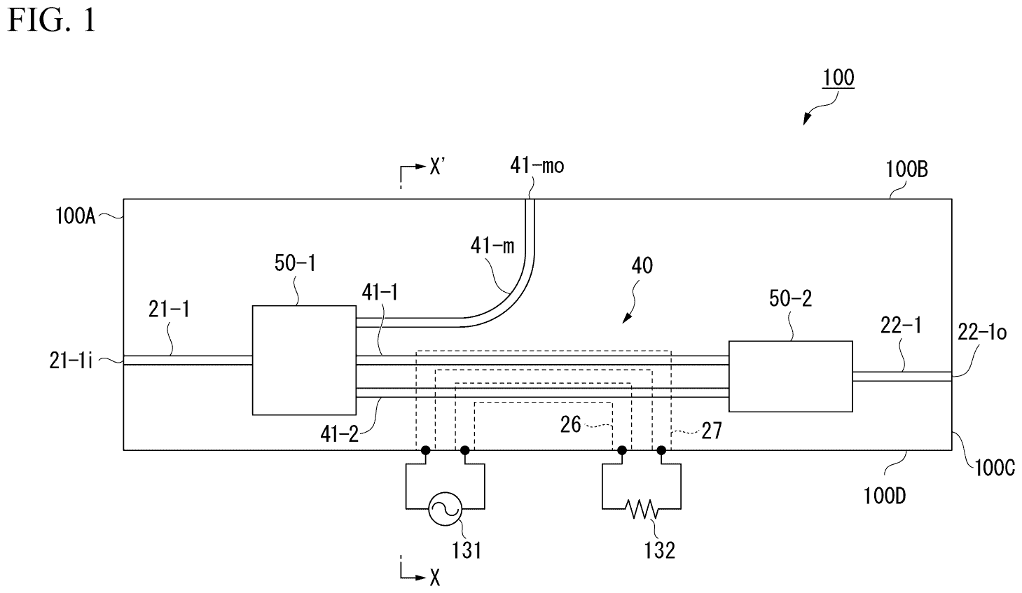

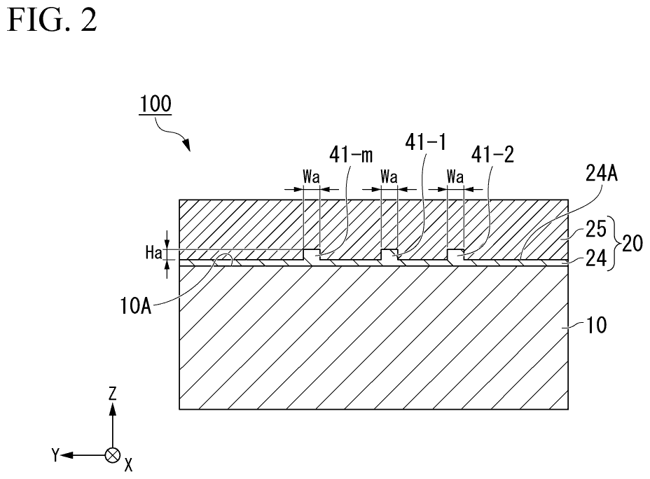

FIG. 1 is a schematic plan view showing an electro-optical element according to a first embodiment. FIG. 2 is a schematic cross-sectional view of the electro-optical element shown in FIG. 1 cut along X-X′.

An electro-optical element 100 shown in FIG. 1 includes a substrate 10, and an optical function layer 20 which is formed on a main surface 10a of the substrate 10. The optical function layer 20 has a light input port 21-1i configured to allow visible light emitted from a visible laser light source to be input therethrough, an optical branching part 50-1 in which a light input side optical waveguide 21-1 guiding visible light input through the light input port 21-1i is connected to one optical waveguide for monitoring 41-m and two optical modulation optical waveguides 41-1 and 41-2, a Mach-Zehnder optical modulation part 40 configured to modulate visible light guided by the two optical modulation optical waveguides 41-1 and 41-2, a two-input one-output type (2×1 type) optical coupling part 50-2 configured to couple two beams of visible light modulated by the Mach-Zehnder optical modulation part 40, a light output side waveguide 22-1 configured to guide light coupled by the optical coupling part 50-2 to a light output port 22-10, the light output port 22-10 through which light guided by the light output side waveguide 22-1 is output to the outside, and a monitoring light output port 41-mo through which light guided by the optical waveguide for monitoring 41-m is output toward a photodetector.

In the electro-optical element 100 shown in FIG. 1, laser light input to the light input port 21-1i from the visible laser light source is caused to branch into three optical waveguides by the one-input three-output type (1×3 type) optical branching part 50-1, and light guided by one optical waveguide thereof serves as monitoring light. In this constitution, only ⅓ of an intensity of laser light input to the light input port 21-1i (Pin) can be used for monitoring (Pmonitor=⅓ Pin), and the remaining ⅔ can be used for outputting light (Pout=⅔ Pin). That is, ⅔ of the intensity of input light can be used for output light so that the efficiency of output light with respect to input light is improved to ⅔.

The electro-optical element 100 shown in FIG. 1 is constituted to have four side surfaces 100A, 100B, 100C, and 100D, in which the light input port 21-1i is provided on the first side surface 100A, the light output port 22-10 is provided on the third side surface 100C, and the monitoring light output port 41-mo is provided on the second side surface 100B, but the constitution is not limited to this. Inputting and outputting may be performed on an upper surface of the electro-optical element 100 using a structure such as a grating coupler or a mirror in the light input port 21-1i, the light output port 22-10, and the monitoring light output port 41-mo. At this time, there is no need for the light input port 21-1i, the light output port 22-10, and the monitoring light output port 41-mo to be provided on the four side surfaces 100A, 100B, 100C, and 100D and may be provided anywhere on the upper surface of the electro-optical element 100.

A known optical branching part and a known optical coupling part can be used as the optical branching part 50-1 and the optical coupling part 50-2. However, both can be multimode interferometer (MMI) type. By having multimode interferometers, deterioration in efficiency due to manufacturing variations can be reduced.

In the electro-optical element 100 shown in FIG. 1, there are two optical modulation optical waveguides for guiding light which has branched by the optical branching part 50-1, but two is an example. The number is not limited to two, and a plurality of (three or more) optical modulation optical waveguides can be provided.

A known constitution can be used for the Mach-Zehnder optical modulation part 40.

Electrodes 26 and 27 are electrodes applying modulation voltages to the Mach-Zehnder optical modulation part 40. One end of the electrode 26 is connected to a power source 131, and the other end thereof is connected to a terminating resistor 132. One end of the electrode 27 is connected to the power source 131, and the other end thereof is connected to the terminating resistor 132. The power source 131 is a part of a drive circuit applying a modulation voltage to the Mach-Zehnder optical modulation part 40.

In the electro-optical element 100 shown in FIG. 1, the substrate 10 can be made of a material different from lithium niobate, and the optical function layer 20 can be made of lithium niobate.

By using a lithium niobate film for the optical function layer 20 propagating visible light, visible light can be propagated with a low loss.

In the electro-optical element 100, when a refractive index difference between a waveguide core film and a waveguide cladding film is Δn, if the waveguide core film is made of lithium niobate, it can be designed to have a larger Δn than in the case of using a material such as a glass, and curvature radii of the optical waveguides can be reduced. Moreover, increase in coupling length is prevented using a multimode interference optical coupling part compared to the case of using a directional coupler, and therefore both improvement in degree of freedom in design and miniaturization can be achieved.

The optical function layer 20 is constituted of a waveguide core film 24 which includes the light input port 21-1i, the light input side optical waveguide 21-1, the one optical waveguide for monitoring 41-m, the two optical modulation optical waveguides 41-1 and 41-2, the optical branching part 50-1, the Mach-Zehnder optical modulation part 40, the optical coupling part 50-2, the light output side waveguide 22-1, the light output port 22-10, and the monitoring light output port 41-mo; and a waveguide cladding (buffer) film 25 which is formed on the waveguide core film 24 such that these are covered. Hereinafter, the reference sign 24 can also be used for the lithium niobate film.

Examples of the substrate 10 can include a sapphire substrate, a Si substrate, and a thermal oxidation silicon substrate.

Since the optical function layer 20 is constituted of a lithium niobate (LiNbO₃) film, it is not particularly limited as long as it has a lower refractive index than the lithium niobate film. However, a sapphire single crystal substrate or a silicon single crystal substrate is preferably used as a substrate on which a single crystal lithium niobate film can be formed as an epitaxial film. The crystal orientation of the single crystal substrate is not particularly limited. However, for example, since the lithium niobate film with a c-axis orientation has three-fold symmetry, it is desirable that the single crystal substrate (base) also have the same symmetry, and it is preferable to use a substrate having a c plane in the case of a sapphire single crystal substrate and use a substrate having a (111) plane in the case of a silicon single crystal substrate.

For example, the lithium niobate film is a c-axis oriented lithium niobate film. For example, the lithium niobate film is an epitaxial film which is epitaxially grown on the substrate 10. The epitaxial film denotes a single crystal film in which the crystal orientation is aligned by the base substrate. The epitaxial film is a film having a single crystal orientation in a z direction and an in-plane direction within an xy plane, in which crystals are oriented in a manner of being aligned in all of an x axis direction, a y axis direction, and a z axis direction. Whether or not a film formed on the substrate 10 is an epitaxial film can be verified by checking the peak intensity and the pole at the orientation position in 2θ-θ X-ray diffraction, for example.

Specifically, when measurement is performed with 2θ-θ X-ray diffraction, all peak intensities except for that in a target plane are equal to or lower than 10% and are preferably equal to or lower than 5% of the maximum peak intensity in the target plane. For example, when the lithium niobate film is a c-axis oriented epitaxial film, the peak intensities except for that in a (00L) plane are equal to or lower than 10% and are preferably equal to or lower than 5% of the maximum peak intensity in the (00L) plane. Here, (00L) is a general term for equivalent planes such as (001) and (002).

In addition, conditions for confirming the peak intensity at the orientation position described above simply indicate the orientation in one direction. Thus, even if the conditions described above are met, when the crystal orientation is not aligned within a plane, the intensity of X-rays does not increase at a particular angular position, and no poles are observed. For example, in the case of the lithium niobate film, since LiNbO₃ has a trigonal crystal structure, there are three poles of LiNbO₃ (014) in a single crystal. In the case of lithium niobate, it is known that epitaxial growth occurs in a so-called twin crystal state in which crystals rotated by 180° about the c-axis are symmetrically coupled. In this case, since two poles are in a symmetrically coupled state in each of three poles, there are six poles. In addition, when a lithium niobate film is formed on a silicon single crystal substrate having a (100) plane, since the substrate has four-fold symmetry, twelve poles (4×3=12) are observed. In the present disclosure, a lithium niobate film which has been epitaxially grown in a twin crystal state is also included in an epitaxial film.

The composition of lithium niobate is LiₓNbA_{y}O_{z}. A is an element other than Li, Nb, and O. The subscript x is 0.5 to 1.2 and is preferably 0.9 to 1.05. The subscript y is 0 to 0.5. The subscript z is 1.5 to 4.0 and is preferably 2.5 to 3.5. For example, the element A is K, Na, Rb, Cs, Be, Mg, Ca, Sr, Ba, Ti, Zr, Hf, V, Cr, Mo, W, Fe, Co, Ni, Zn, Sc, or Ce, and two or more kinds of these elements may be combined.

Moreover, a lithium niobate single crystal thin film pasted on a substrate may be adopted as the lithium niobate film.

The film thickness of the lithium niobate film is 2 μm or smaller, for example. The film thickness of the lithium niobate film indicates the film thickness of a part other than ridges. Optimal design of the film thickness of the lithium niobate film may be suitably performed in accordance with the wavelength, the ridge shape, and the like used.

A waveguide is a ridge protruding from a first surface 24A of the lithium niobate film 24. The first surface 24A is an upper surface of the lithium niobate film 24 in a part (slab layer) except for the ridges.

Cross-sectional shape forming portions of the optical waveguide for monitoring 41-m and the two optical modulation optical waveguides 41-1 and 41-2 each have a rectangular cross-sectional shape. However, they need only have a shape capable of guiding light. For example, they may have a trapezoidal shape, a triangular shape, a semicircular shape, or the like. Widths Wa of three ridges in a y direction are preferably 0.2 μm to 5.0 μm, and heights of the three ridges (protrusion heights Ha from the first surface 24A) are preferably 0.1 μm to 1.0 μm, for example. The same applies to other optical waveguides.

Propagation in a single mode can be achieved by setting the cross-sectional dimensions of the optical waveguide to approximately the wavelength of laser light.

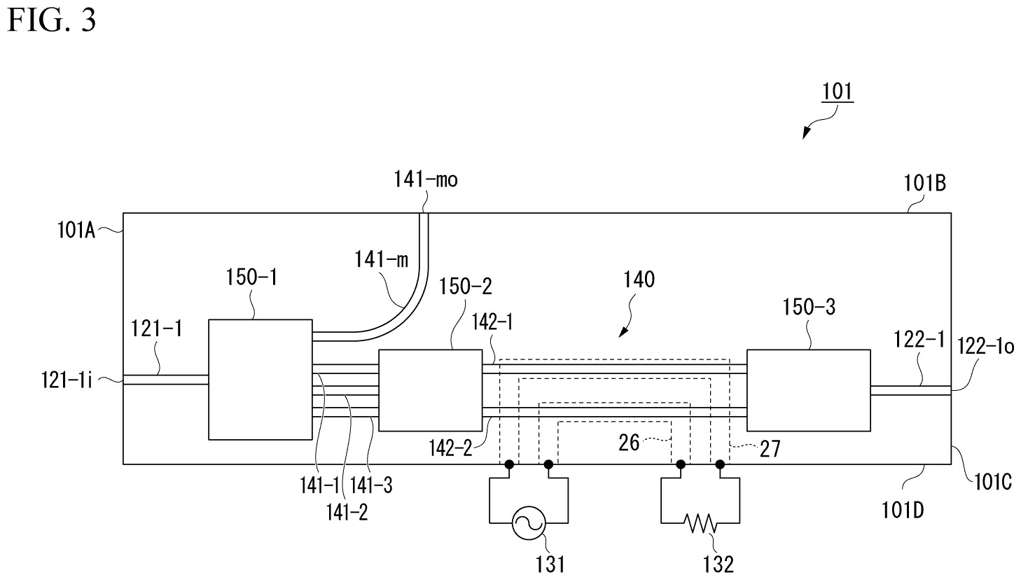

FIG. 3 is a schematic plan view showing an electro-optical element according to a second embodiment. Hereinafter, illustration and description of parts common to those of the electro-optical element according to the first embodiment may be omitted.

An electro-optical element 101 shown in FIG. 3 includes the substrate 10 (refer to FIG. 2), and the optical function layer 20 (refer to FIG. 2) which is formed on the main surface 10a of the substrate 10 (refer to FIG. 2). The optical function layer 20 has a light input port 121-1i configured to allow visible light emitted from a visible laser light source to be input therethrough; an optical branching part 150-1 in which a light input side optical waveguide 121-1 guiding visible light input through the light input port 121-1i is connected to one optical waveguide for monitoring 141-m and three optical modulation optical waveguides 141-1, 141-2, and 141-3; a 3×2 type optical coupling/branching part 150-2, in which the three optical modulation optical waveguides 141-1, 141-2, and 141-3 are connected to an incidence side and optical modulation optical waveguides 142-1 and 142-2 connected to a Mach-Zehnder optical modulation part 140 are connected to an emission side, is provided between the optical branching part 150-1 and the Mach-Zehnder optical modulation part 140; the Mach-Zehnder optical modulation part 140 configured to modulate visible light guided by the two optical modulation optical waveguides 142-1 and 142-2; a two-input one-output type (2×1 type) optical coupling part 150-3 configured to couple two beams of visible light modulated by the Mach-Zehnder optical modulation part 140; a light output side waveguide 122-1 configured to guide light coupled by the optical coupling part 150-3 to a light output port 122-10; the light output port 122-10 through which light guided by the light output side waveguide 122-1 is output to the outside; and a monitoring light output port 141-mo through which light guided by the optical waveguide for monitoring 141-m is output toward a photodetector.

In the electro-optical element 101 shown in FIG. 3, laser light input to the light input port 121-1i from the visible laser light source is caused to branch into four optical waveguides by the one-input four-output type (1×4 type) optical branching part 150-1, and light guided by one optical waveguide thereof is used as monitoring light. In this constitution, only ¼ of the intensity of laser light input to the light input port 121-1i (Pin) can be used for monitoring (Pmonitor=¼ Pin), and the remaining ¾ can be used for outputting light (Pout=¾ Pin). That is, ¾ of the intensity of input light can be used for output light so that the efficiency of output light with respect to input light is improved to ¾.

The electro-optical element 101 shown in FIG. 3 is constituted to have four side surfaces 101A, 101B, 101C, and 101D, in which the light input port 121-1i is provided on the first side surface 101A, the light output port 122-10 is provided on the third side surface 101C, and the monitoring light output port 141-mo is provided on the second side surface 101B, but the constitution is not limited to this. Inputting and outputting may be performed on an upper surface of the electro-optical element 101 using a structure such as a grating coupler or a mirror in the light input port 121-1i, the light output port 122-10, and the monitoring light output port 141-mo. At this time, there is no need for the light input port 121-1i, the light output port 122-10, and the monitoring light output port 141-mo to be provided on the four side surfaces 101A, 101B, 101C, and 101D and may be provided anywhere on the upper surface of the electro-optical element 101.

A known optical branching part, a known optical coupling/branching part, and a known optical coupling part can be used as the optical branching part 150-1, the 3×2 type optical coupling/branching part 150-2, and the optical coupling part 150-3. However, both can be multimode interferometer (MMI) type. By having multimode interferometers, deterioration in efficiency due to manufacturing variations can be reduced.

In the electro-optical element 101 shown in FIG. 3, there are three optical modulation optical waveguides (the optical modulation optical waveguides 141-1, 141-2, and 141-3) for guiding light which has branched by the optical branching part 150-1, but three is an example. The number is not limited to three, and a plurality of ((N₁−1) or more (N₁ is an integer equal to or larger than 3)) optical modulation optical waveguides can be provided. In this constitution, only 1/N₁ of the intensity of laser light input to the light input port 121-1i (Pin) can be used for monitoring (Pmonitor=1/N₁ Pin), and the remaining (N₁−1)/N₁ can be used for outputting light (Pout=(N₁−1)/N₁ Pin). That is, (N₁−1)/N₁ of the intensity of input light can be used for output light so that the efficiency of output light with respect to input light is improved to (N₁−1)/N₁.

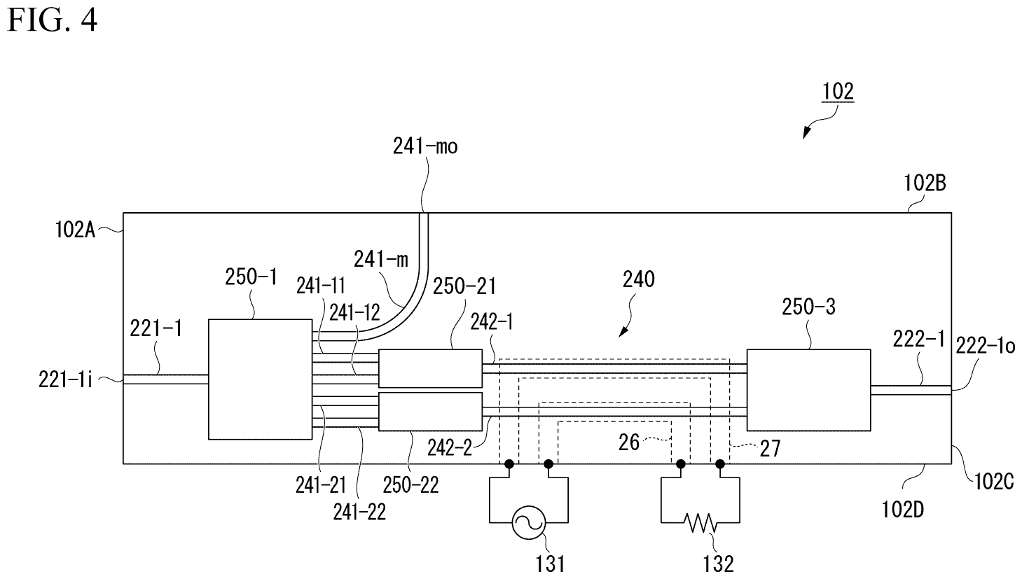

FIG. 4 is a schematic plan view showing an electro-optical element according to a third embodiment. Hereinafter, illustration and description of parts common to those of the electro-optical element according to the foregoing embodiments may be omitted.

An electro-optical element 102 shown in FIG. 4 includes the substrate 10 (refer to FIG. 2), and the optical function layer 20 (refer to FIG. 2) which is formed on the main surface 10a of the substrate 10 (refer to FIG. 2). The optical function layer 20 has a light input port 221-1i configured to allow visible light emitted from a visible laser light source to be input therethrough; an optical branching part 250-1 in which a light input side optical waveguide 221-1 guiding visible light input through the light input port 221-1i is connected to one optical waveguide for monitoring 241-m and four optical modulation optical waveguides 241-11, 241-12, 241-21, and 241-22; two 2×1 type optical coupling/branching parts 250-21 and 250-22, in which the optical modulation optical waveguides 241-11, 241-12, 241-21, and 241-22 are connected to an incidence side and optical modulation optical waveguides 242-1 and 242-2 connected to a Mach-Zehnder optical modulation part 240 are connected to an emission side, is provided between the optical branching part 250-1 and the Mach-Zehnder optical modulation part 240; the Mach-Zehnder optical modulation part 240 configured to modulate visible light guided by the two optical modulation optical waveguides 242-1 and 242-2; a two-input one-output type (2×1 type) optical coupling part 250-3 configured to couple two beams of visible light modulated by the Mach-Zehnder optical modulation part 240; a light output side waveguide 222-1 configured to guide light coupled by the optical coupling part 250-3 to a light output port 222-10; the light output port 222-10 through which light guided by the light output side waveguide 222-1 is output to the outside; and a monitoring light output port 241-mo through which light guided by the optical waveguide for monitoring 241-m is output toward a photodetector.

In the electro-optical element 102 shown in FIG. 4, laser light input to the light input port 221-1i from the visible laser light source is caused to branch into five optical waveguides by the one-input five-output type (1×5 type) optical branching part 250-1, and light guided by one optical waveguide thereof is used as monitoring light. In this constitution, only ⅕ of the intensity of laser light input to the light input port 221-1i (Pin) can be used for monitoring (Pmonitor=⅕ Pin), and the remaining ⅘ can be used for outputting light (Pout=⅘ Pin). That is, ⅘ of the intensity of input light can be used for output light so that the efficiency of output light with respect to input light is improved to ⅘.

The electro-optical element 102 shown in FIG. 4 is constituted to have four side surfaces 102A, 102B, 102C, and 102D, in which the light input port 221-1i is provided on the first side surface 102A, the light output port 222-10 is provided on the third side surface 102C, and the monitoring light output port 241-mo is provided on the second side surface 102B, but the constitution is not limited to this. Inputting and outputting may be performed on an upper surface of the electro-optical element 102 using a structure such as a grating coupler or a mirror in the light input port 221-1i, the light output port 222-10, and the monitoring light output port 241-mo. At this time, there is no need for the light input port 221-1i, the light output port 222-10, and the monitoring light output port 241-mo to be provided on the four side surfaces 102A, 102B, 102C, and 102D and may be provided anywhere on the upper surface of the electro-optical element 102.

A known optical branching part, a known optical coupling/branching part, and a known optical coupling part can be used as the optical branching part 250-1, the two 2×1 type optical coupling/branching parts 250-21 and 250-22, and the optical coupling part 250-3. However, both can be multimode interferometer (MMI) type. By having multimode interferometers, deterioration in efficiency due to manufacturing variations can be reduced.

Both the two optical coupling/branching parts 250-21 and 250-22 are 2×1 type optical coupling/branching parts. However, when the optical branching part 250-1 is constituted to perform outputting to (2N₂×1) optical waveguides, there are two N₂×1 type optical coupling/branching parts.

In the electro-optical element 102 shown in FIG. 4, there are four optical modulation optical waveguides (the optical modulation optical waveguides 241-11, 241-12, 241-21, and 241-22) for guiding light which has branched by the optical branching part 250-1, but four is an example. The number is not limited to four, and a plurality of (2N₂ or more (N₂ is an integer equal to or larger than 2)) optical modulation optical waveguides can be provided. In this constitution, only 1/(2N₂+1) of the intensity of laser light input to the light input port 221-1i (Pin) can be used for monitoring (Pmonitor=1/(2N₂+1) Pin), and the remaining 2N₂/(2N₂+1) can be used for outputting light (Pout=2N₂/(2N₂+1) Pin). That is, 2N₂/(2N₂+1) of the intensity of input light can be used for output light so that the efficiency of output light with respect to input light is improved to 2N₂/(2N₂+1).

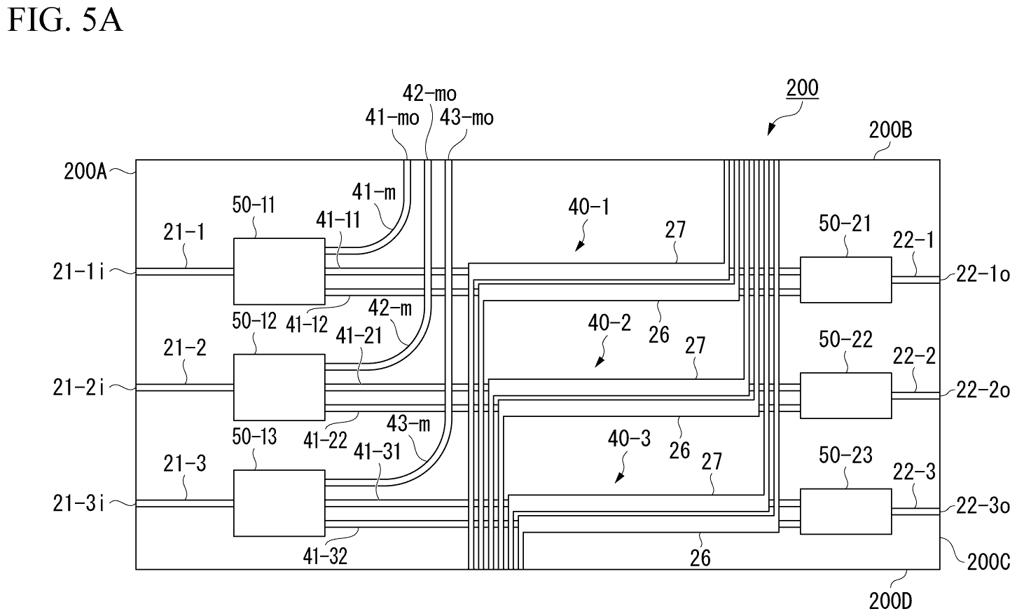

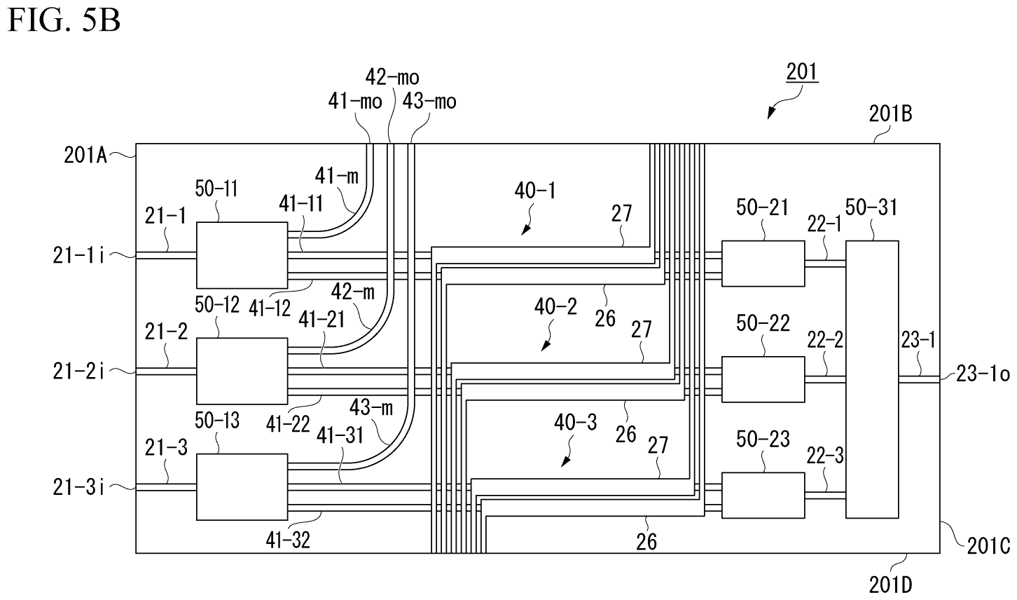

FIG. 5A is a schematic plan view showing a modification example of an electro-optical element according to the first embodiment. Hereinafter, illustration and description of parts common to those of the electro-optical element according to the foregoing embodiments may be omitted. The electro-optical element described using FIGS. 1 and 2 is constituted to include one light input port and one light output port and modulate visible light output from one visible laser light source. However, this modification example is constituted to include three light input ports which allow three beams of visible light having different wavelengths and respectively output from three visible laser light sources to be input therethrough, and three light output ports which output three beams of visible light having different wavelengths to the outside. Hereinafter, a case in which three beams of visible light having different wavelengths are beams of visible light respectively output from three-color (RGB) visible laser light sources will be described as an example.

Here, light having a peak wavelength of 600 nm to 830 nm can be used as red (R) laser light, light having a peak wavelength of 500 nm to 600 nm can be used as green (G) laser light, and light having a peak wavelength of 380 nm to 500 nm can be used as blue (B) laser light.

An electro-optical element 200 shown in FIG. 5A includes the substrate 10 (refer to FIG. 2), and the optical function layer 20 (refer to FIG. 2) which is formed on the main surface 10a of the substrate 10 (refer to FIG. 2).

The optical function layer 20 has the light input port 21-1i configured to allow visible light emitted from a red laser light source to be input therethrough, an optical branching part 50-11 in which the light input side optical waveguide 21-1 guiding red laser light input through the light input port 21-1i is connected to the one optical waveguide for monitoring 41-m and two optical modulation optical waveguides 41-11 and 41-12, a Mach-Zehnder optical modulation part 40-1 configured to modulate red laser light guided by the two optical modulation optical waveguides 41-11 and 41-12, a two-input one-output type (2×1 type) optical coupling part 50-21 configured to couple two beams of red laser light modulated by the Mach-Zehnder optical modulation part 40-1, the light output side waveguide 22-1 configured to guide red laser light coupled by the optical coupling part 50-21 to the light output port 22-10, the light output port 22-10 through which red laser light guided by the light output side waveguide 22-1 is output to the outside, and the monitoring light output port 41-mo through which red laser light guided by the optical waveguide for monitoring 41-m is output toward a photodetector.

The optical function layer 20 further has a light input port 21-2i configured to allow visible light emitted from a green laser light source to be input therethrough, an optical branching part 50-12 in which a light input side optical waveguide 21-2 guiding green laser light input through the light input port 21-2i is connected to one optical waveguide for monitoring 42-m and two optical modulation optical waveguides 41-21 and 41-22, a Mach-Zehnder optical modulation part 40-2 configured to modulate green laser light guided by the two optical modulation optical waveguides 41-21 and 41-22, a two-input one-output type (2×1 type) optical coupling part 50-22 configured to couple two beams of green laser light modulated by the Mach-Zehnder optical modulation part 40-2, a light output side waveguide 22-2 configured to guide green laser light coupled by the optical coupling part 50-22 to a light output port 22-20, the light output port 22-20 through which green laser light guided by the light output side waveguide 22-2 is output to the outside, and a monitoring light output port 42-mo through which green laser light guided by the optical waveguide for monitoring 42-m is output toward a photodetector.

The optical function layer 20 further has a light input port 21-3i configured to allow visible light emitted from a blue laser light source to be input therethrough, an optical branching part 50-13 in which a light input side optical waveguide 21-3 guiding blue laser light input through the light input port 21-3i is connected to one optical waveguide for monitoring 43-m and two optical modulation optical waveguides 41-31 and 41-32, a Mach-Zehnder optical modulation part 40-3 configured to modulate blue laser light guided by the two optical modulation optical waveguides 41-31 and 41-32, a two-input one-output type (2×1 type) optical coupling part 50-23 configured to couple two beams of blue laser light modulated by the Mach-Zehnder optical modulation part 40-3, a light output side waveguide 22-3 configured to guide blue laser light coupled by the optical coupling part 50-23 to a light output port 22-30, the light output port 22-30 through which blue laser light guided by the light output side waveguide 22-3 is output to the outside, and a monitoring light output port 43-mo through which blue laser light guided by the optical waveguide for monitoring 43-m is output toward a photodetector.

In the electro-optical element 200 shown in FIG. 5A, red laser light input to the light input port 21-1i from the red laser light source is caused to branch into three optical waveguides by the one-input three-output type (1×3 type) optical branching part 50-11, and light guided by one optical waveguide thereof is used as monitoring light. In this constitution, only ⅓ of the intensity of red laser light input to the light input port 21-1i (Pin) can be used for monitoring (Pmonitor=⅓ Pin), and the remaining ⅔ can be used for outputting light (Pout=⅔ Pin). That is, ⅔ of the intensity of input light of a red laser can be used for output light so that the efficiency of output light with respect to input light is improved to ⅔.

Similarly, green laser light input to the light input port 21-2i from the green laser light source is caused to branch into three optical waveguides by the one-input three-output type (1×3 type) optical branching part 50-12, and light guided by one optical waveguide thereof is used as monitoring light. In this constitution, only ⅓ of the intensity of green laser light input to the light input port 21-2i (Pin) can be used for monitoring (Pmonitor-⅓ Pin), and the remaining ⅔ can be used for outputting light (Pout=⅔ Pin). That is, ⅔ of the intensity of input light of a green laser can be used for output light so that the efficiency of output light with respect to input light is improved to ⅔.

Similarly, blue laser light input to the light input port 21-3i from the blue laser light source is caused to branch into three optical waveguides by the one-input three-output type (1×3 type) optical branching part 50-13, and light guided by one optical waveguide thereof is used as monitoring light. In this constitution, only ⅓ of the intensity of blue laser light input to the light input port 21-3i (Pin) can be used for monitoring (Pmonitor=⅓ Pin), and the remaining ⅔ can be used for outputting light (Pout=⅔ Pin). That is, ⅔ of the intensity of input light of a blue laser can be used for output light so that the efficiency of output light with respect to input light is improved to The electro-optical element 200 shown in FIG. 5A is constituted to have four side surfaces 200A, 200B, 200C, and 200D, in which the light input ports 21-1i, 21-2i, and 21-3i are provided on the first side surface 200A, the light output ports 22-10, 22-20, and 22-30 are provided on the third side surface 200C, and the monitoring light output ports 41-mo, 42-mo, and 43-mo are provided on the second side surface 200B, but the constitution is not limited to this. Inputting and outputting may be performed on an upper surface of the electro-optical element 200 using a structure such as a grating coupler or a mirror in the light input ports 21-1i, 21-2i, and 21-3i, the light output ports 22-10, 22-20, and 22-30, and the monitoring light output ports 41-mo, 42-mo, and 43-mo. At this time, there is no need for the light input ports 21-1i, 21-2i, and 21-3i, the light output ports 22-10, 22-20, and 22-30, and the monitoring light output ports 41-mo, 42-mo, and 43-mo to be provided on the four side surfaces 200A, 200B, 200C, and 200D and may be provided anywhere on the upper surface of the electro-optical element 200.

A known optical branching part and a known optical coupling part can be used as the optical branching parts 50-11, 50-12, and 50-13, and the optical coupling parts 50-21, 50-22, and 50-23. However, both can be multimode interferometer (MMI) type. By having multimode interferometers, deterioration in efficiency due to manufacturing variations can be reduced.

In the electro-optical element 200 shown in FIG. 5A, there are two optical modulation optical waveguides for guiding light which has branched by the optical branching part 50-11, two optical modulation optical waveguides for guiding light which has branched by the optical branching part 50-12, and two optical modulation optical waveguides for guiding light which has branched by the optical branching part 50-13, but two is an example. The number is not limited to two, and a plurality of (three or more) optical modulation optical waveguides can be provided.

Hereinabove, regarding a modification example of the electro-optical element according to the first embodiment, an electro-optical element enabling modulation of each of three beams of visible light having different wavelengths has been described. However, similarly in the electro-optical element according to the second embodiment and the electro-optical element according to the third embodiment as well, the electro-optical element enabling modulation of each of three different beams of visible light can be produced on the basis of the electro-optical element enabling modulation of visible light having one wavelength.

FIG. 5B is a schematic plan view showing another modification example of an electro-optical element according to the first embodiment. Hereinafter, illustration and description of parts common to those of the foregoing electro-optical elements may be omitted. The example shown in FIG. 5A has a constitution including three light output ports for outputting three beams of visible light having different wavelengths to the outside, in which respective beams of visible light are output through three light output ports. Meanwhile, the example shown in FIG. 5B has a constitution including a coupling portion configured to couple three beams of visible light having different wavelengths and one light output port through which coupled light is output to the outside, in which three beams of visible light having different wavelengths are coupled and output. Hereinafter, a case in which three beams of visible light having different wavelengths are beams of visible light respectively output from three-color (RGB) visible laser light sources will be described as an example.

An electro-optical element 201 shown in FIG. 5B includes the substrate 10 (refer to FIG. 2), and the optical function layer 20 (refer to FIG. 2) which is formed on the main surface 10a of the substrate 10 (refer to FIG. 2).

In addition to a constitution similar to that of the electro-optical element 200 shown in FIG. 5A, the optical function layer 20 includes a three-input one-output type optical coupling part 50-31 which has, as inputs, the light output side waveguide 22-1 guiding red laser light coupled by the optical coupling part 50-21, the light output side waveguide 22-2 guiding green laser light coupled by the optical coupling part 50-22, and the light output side waveguide 22-3 guiding blue laser light coupled by the optical coupling part 50-23 and couples these RGB beams of laser light and outputs them to a light output side waveguide 23-1; and a light output port 23-10 which outputs RGB coupled light guided by the light output side waveguide 23-1 to the outside.

The electro-optical element 201 shown in FIG. 5B is the same as the electro-optical element 200 shown in FIG. 5A in that the intensities of beams of light branching as monitoring light of respective RGB beams of laser light are only ⅓ (Pmonitor=⅓ Pin) of the intensities of respective RGB beams of laser light input to the respective light input ports (Pin). Therefore, similar to the electro-optical element 200 shown in FIG. 5A, ⅔ of the intensity of input light of respective RGB beams of laser light can be used for output light so that the efficiency of output light with respect to input light is improved to ⅔.

The electro-optical element 201 shown in FIG. 5B is constituted to have four side surfaces 201A, 201B, 201C, and 201D, in which the light input ports 21-1i, 21-2i, and 21-3i are provided on the first side surface 201A, the light output port 23-10 is provided on the third side surface 201C, and the monitoring light output ports 41-mo, 42-mo, and 43-mo are provided on the second side surface 201B, but the constitution is not limited to this. Inputting and outputting may be performed on an upper surface of the electro-optical element 201 using a structure such as a grating coupler or a mirror in the light input ports 21-1i, 21-2i, and 21-3i, the light output port 23-10, and the monitoring light output ports 41-mo, 42-mo, and 43-mo. At this time, there is no need for the light input ports 21-1i, 21-2i, and 21-3i, the light output port 23-10, and the monitoring light output ports 41-mo, 42-mo, and 43-mo to be provided on the four side surfaces 201A, 201B, 201C, and 201D and may be provided anywhere on the upper surface of the electro-optical element 201.

Similar to the optical branching parts 50-11, 50-12, and 50-13 and the optical coupling parts 50-21, 50-22, and 50-23, a known optical branching part and a known optical coupling part can be used as the optical coupling part 50-31. However, both can be multimode interferometer (MMI) type. By having multimode interferometers, deterioration in efficiency due to manufacturing variations can be reduced.

Hereinabove, regarding another modification example of the electro-optical element according to the first embodiment, an electro-optical element enabling modulation of each of three beams of visible light having different wavelengths has been described. However, similarly in the electro-optical element according to the second embodiment and the electro-optical element according to the third embodiment as well, the electro-optical element enabling modulation of each of three different beams of visible light can be produced on the basis of the electro-optical element enabling modulation of visible light having one wavelength.

### [Light Source Module]

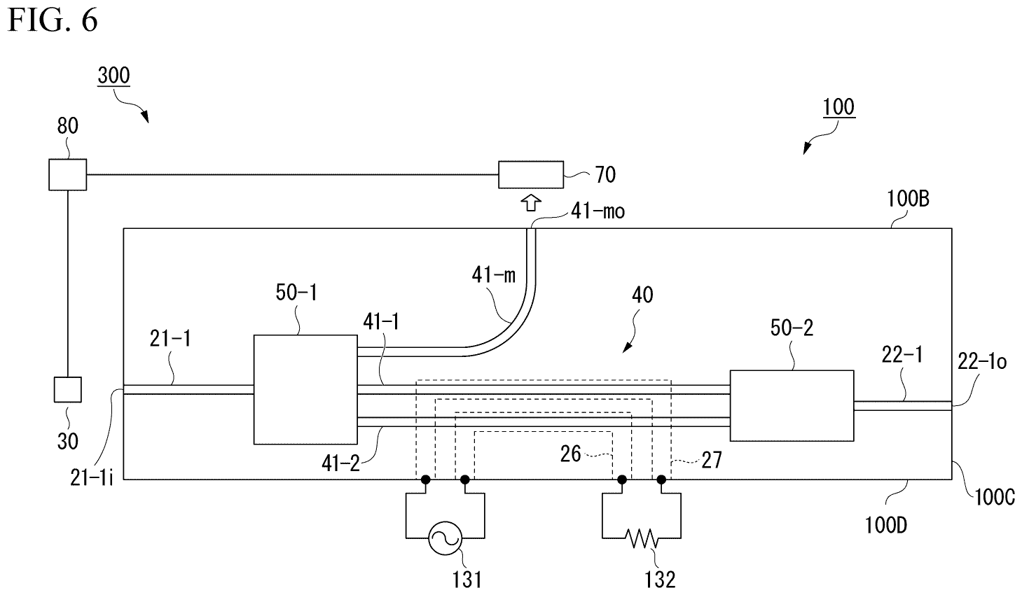

FIG. 6 is a schematic plan view showing a light source module according to a fourth embodiment. Hereinafter, illustration and description of parts common to those of the foregoing constitutions may be omitted.

A light source module 300 shown in FIG. 6 includes the electro-optical element 100 shown in FIG. 1, a visible laser light source 30 which outputs visible light input through the light input port 21-1i, and a laser light intensity control part 80 which detects monitoring light from the monitoring light output port 41-mo using a photodetector 70 and adjusts an intensity of laser light emitted from the visible laser light source 30 in accordance with an intensity of detected light.

Various kinds of laser elements can be used as the visible laser light source 30. For example, commercially available laser diodes (LDs) of red light, green light, blue light, and the like can be used. Light having a peak wavelength of 600 nm to 830 nm can be used as red light, light having a peak wavelength of 500 nm to 600 nm can be used as green light, and light having a peak wavelength of 380 nm to 500 nm can be used as blue light.

A known photodetector can be used as the photodetector 70.

Regarding the laser light intensity control part 80, it is possible to use a known control system controlling the intensity of laser light by controlling the drive current of the visible laser light source 30 on the basis of a signal of the intensity of monitoring light detected by the photodetector 70.

In the light source module 300 shown in FIG. 6, both current modulation in the visible laser light source and voltage modulation in the Mach-Zehnder optical modulation part can be used.

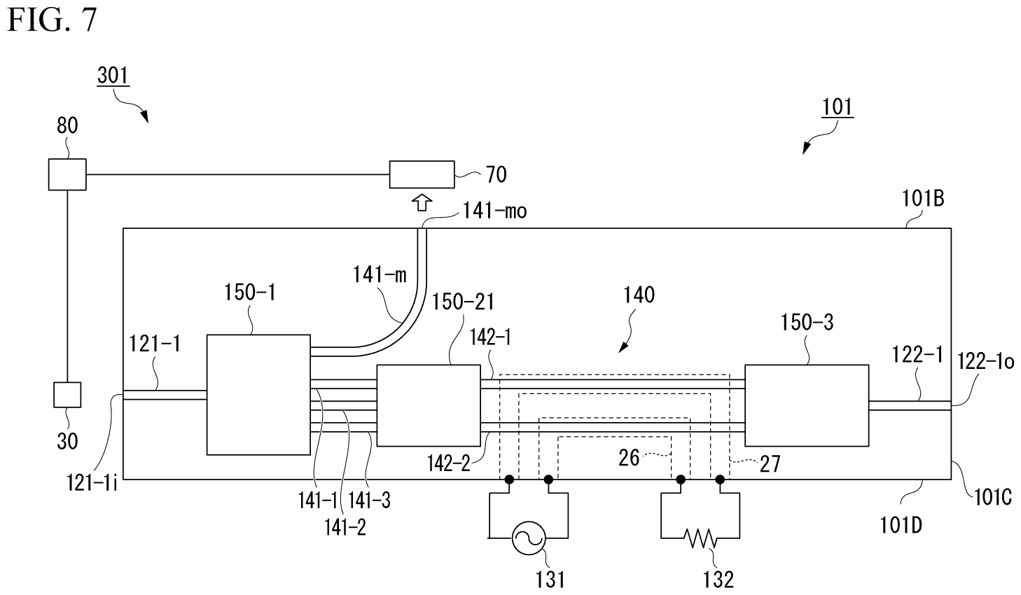

FIG. 7 is a schematic plan view showing a light source module according to a fifth embodiment. Hereinafter, illustration and description of parts common to those of the foregoing constitutions may be omitted.

A light source module 301 shown in FIG. 7 includes the electro-optical element 101 shown in FIG. 3, the visible laser light source 30 which outputs visible light input through the light input port 121-1i, and the laser light intensity control part 80 which detects monitoring light from the monitoring light output port 141-mo using the photodetector 70 and adjusts the intensity of laser light emitted from the visible laser light source 30 in accordance with the intensity of detected light.

In the light source module 301 shown in FIG. 7 as well, similar to the light source module 300 shown in FIG. 6, both current modulation in the visible laser light source and voltage modulation in the Mach-Zehnder optical modulation part can be used.

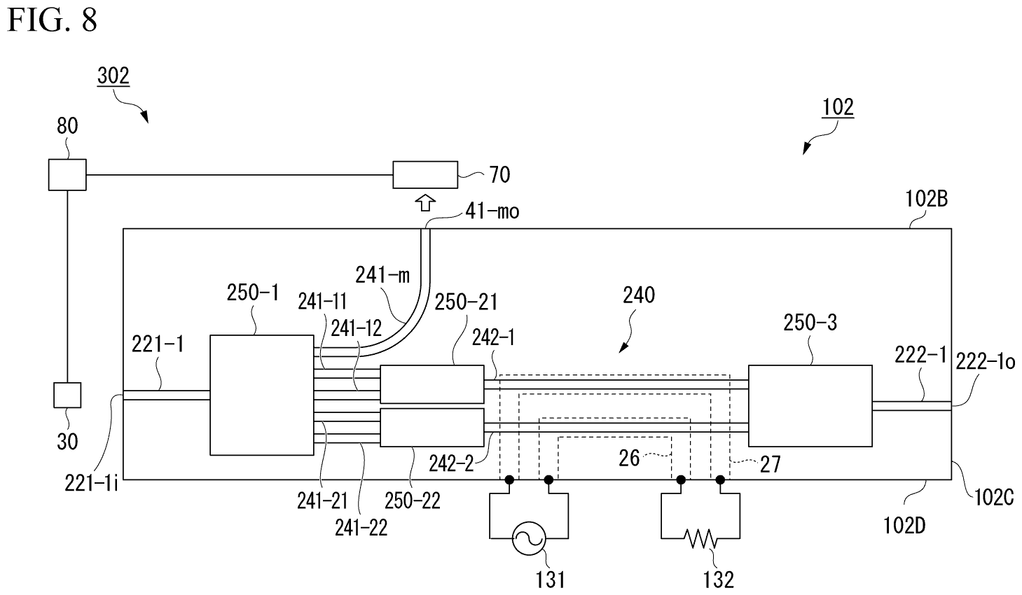

FIG. 8 is a schematic plan view showing a light source module according to a sixth embodiment. Hereinafter, illustration and description of parts common to those of the foregoing constitutions may be omitted.

A light source module 302 shown in FIG. 8 includes the electro-optical element 102 shown in FIG. 4, the visible laser light source 30 which outputs visible light input through the light input port 221-1i, and the laser light intensity control part 80 which detects monitoring light from the monitoring light output port 241-mo using the photodetector 70 and adjusts the intensity of laser light emitted from the visible laser light source 30 in accordance with the intensity of detected light.

In the light source module 302 shown in FIG. 8 as well, similar to the light source module 300 shown in FIG. 6 and the light source module 301 shown in FIG. 7, both current modulation in the visible laser light source and voltage modulation in the Mach-Zehnder optical modulation part can be used.

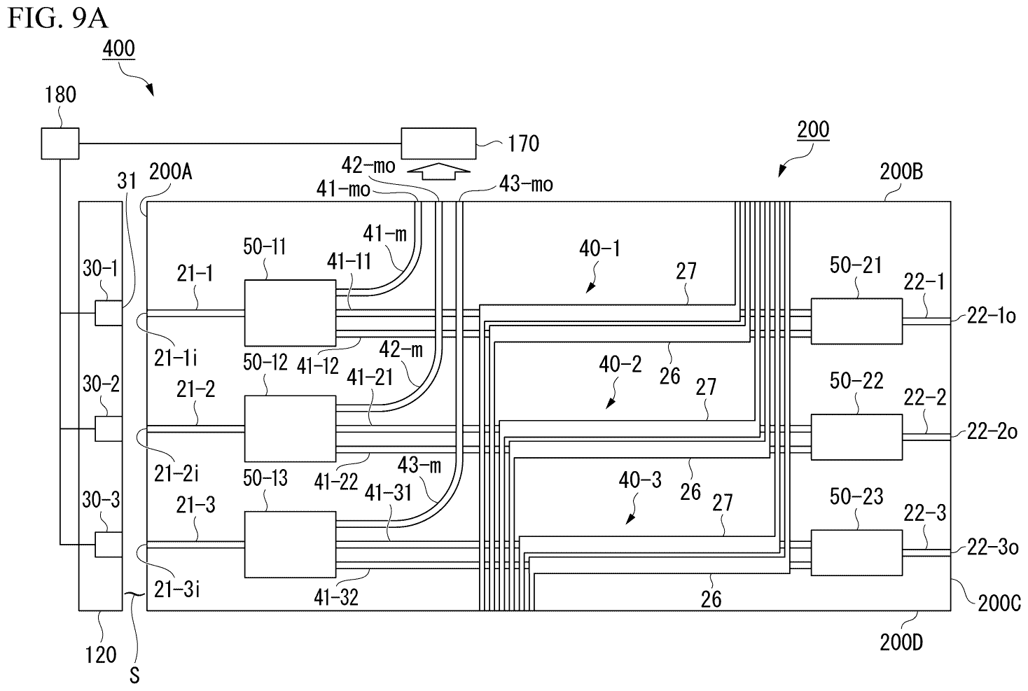

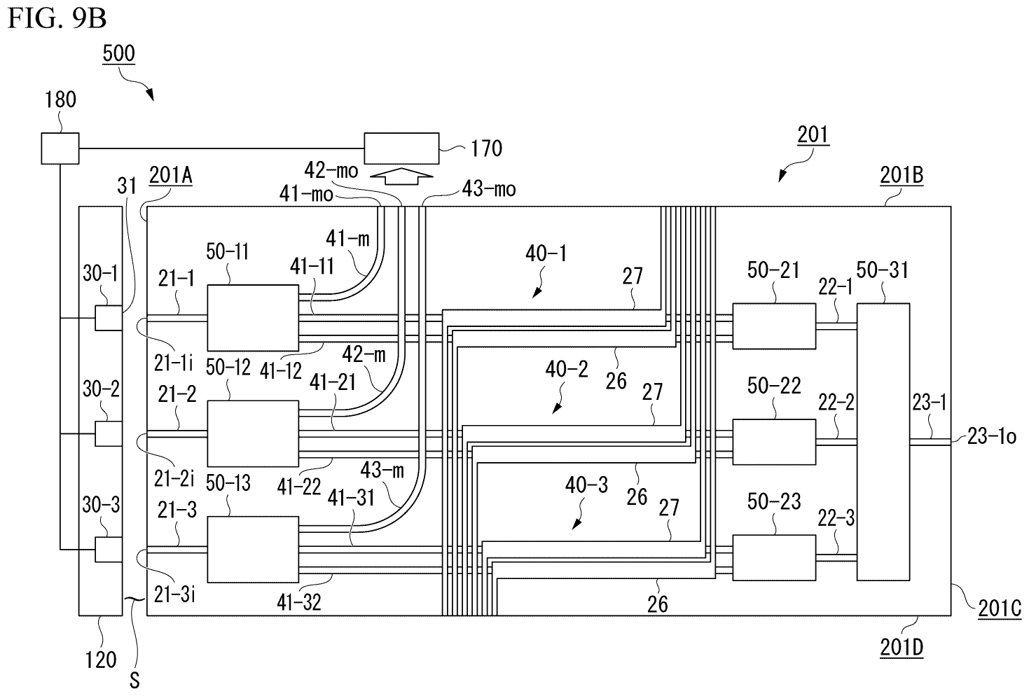

FIG. 9A is a schematic plan view showing a modification example of a light source module according to the fourth embodiment. Hereinafter, illustration and description of parts common to those of the foregoing constitutions may be omitted.

A light source module 400 shown in FIG. 9A includes the electro-optical element 200 shown in FIG. 5A; a red laser light source 30-1 which outputs red laser light input through the light input port 21-1i; a green laser light source 30-2 which outputs green laser light input through the light input port 21-2i; a blue laser light source 30-3 which outputs blue laser light input through the light input port 21-3i; and a laser light intensity control part 180 which can detect monitoring light from each of the monitoring light output port 41-mo, the monitoring light output port 42-mo, and the monitoring light output port 43-mo using a photodetector 170 and can independently adjust the intensities of respective beams of laser light emitted from the red laser light source 30-1, the green laser light source 30-2, and the blue laser light source 30-3 in accordance with the intensities of respective beams of detected laser light.

As above, the light source module 400 shown in FIG. 9A includes the electro-optical element 200 shown in FIG. 5A as the electro-optical element. In FIG. 9A, the constituent elements indicated by the reference signs used in FIG. 5A will be considered as common elements and description thereof will be omitted.

Various kinds of laser elements can be used as the red laser light source 30-1, the green laser light source 30-2, and the blue laser light source 30-3. For example, commercially available laser diodes (LDs) of red light, green light, blue light, and the like can be used.

In the light source module 400, the red laser light source 30-1, the green laser light source 30-2, and the blue laser light source 30-3 are disposed with an interval therebetween in a direction substantially orthogonal to an emission direction of light emitted from each of the laser light sources and are provided on an upper surface of a subcarrier 120.

When the red laser light source 30-1, the green laser light source 30-2, and the blue laser light source 30-3 are laser diodes, for example, they can be mounted on the subcarrier 120 as bare chips. For example, the subcarrier 120 is constituted using aluminum nitride (AlN), aluminum oxide (Al₂O₃), silicon (Si), or the like.

The subcarrier 120 can be constituted to be directly bonded to the substrate 10 with a metal bonding layer therebetween. Due to this constitution, since spatial coupling or fiber coupling is not performed, further miniaturization can be achieved. In FIG. 9A, the red laser light source 30-1, the green laser light source 30-2, and the blue laser light source 30-3 are mounted on one subcarrier 120, but each of the light sources may be separately mounted on a different subcarrier.

Due to the constitution in which the subcarrier 120 and the substrate 10 are bonded with a metal bonding layer therebetween, the optical axes of beams of laser light can be positionally aligned (active alignment) by adjusting relative positions between the subcarrier 120 and the substrate 10 at the time of manufacturing, such that the optical axis of each of the visible laser light sources matches each axis of the light input side optical waveguide 21-1, the light input side optical waveguide 21-2, and the light input side optical waveguide 21-3.

A known photodetector can be used as the photodetector 170.

Regarding the laser light intensity control part 180, it is possible to use a known control system controlling the intensity of laser light by controlling the drive currents of the red laser light source 30-1, the green laser light source 30-2, and the blue laser light source 30-3 on the basis of a signal of the intensity of each ray of monitoring light detected by the photodetector 170.

Light emission surfaces (in FIG. 9A, the light emission surface of the red laser light source 30-1 is indicated by the reference sign 31) of the red laser light source 30-1, the green laser light source 30-2, and the blue laser light source 30-3 and the light incidence surface (side surface) 200A of the electro-optical element 200 are disposed with a predetermined interval therebetween. The light incidence surface 200A faces the light emission surface 31, and there is a gap S between the light emission surface 31 and the light incidence surface 200A in an x direction. Since the light source module 400 is exposed in the air, the gap S is filled with air. Since the gap S is in a state of being filled with the same gas (air), it is easy to cause beams of light of colors respectively emitted from the red laser light source 30-1, the green laser light source 30-2, and the blue laser light source 30-3 to be incident on incidence paths in a state of satisfying predetermined coupling efficiency. When the light source module 400 is used in XR glasses such as AR glasses and VR glasses, in consideration of the amount of light and the like required for XR glasses such as AR glasses and VR glasses, the size of the gap (interval) S in the x direction is larger than 0 μm and is equal to or smaller than 5 μm, for example.

For example, in a retinal projection display, in order to display an image with desired colors, there is a need for the respective intensities of three RGB colors expressing visible light to be independently modulated at a high speed.

If such modulation is performed with respect to only the visible laser light sources (current modulation), the load on an IC controlling the modulation thereof will increase. However, in the light source module 400 shown in FIG. 9A, modulation (voltage modulation) by the Mach-Zehnder optical modulation part can also be used together. In this case, coarse adjustment may be performed using a current (visible laser light source) and fine adjustment may be performed using a voltage (Mach-Zehnder optical modulation part). Alternatively, coarse adjustment may be performed using a voltage (Mach-Zehnder optical modulation part) and fine adjustment may be performed using a current (visible laser light source). Since fine adjustment performed using a voltage has better responsiveness, when responsiveness is regarded as important, it is preferable to employ the former method. Since fine adjustment performed using a current requires a lower current which restrains power consumption, when restraint of power consumption is regarded as important, it is preferable to employ the latter method. In addition, since the Mach-Zehnder optical modulation part can perform high-speed modulation at frequencies exceeding gigahertz, it is possible to obtain high-resolution images.

Hereinabove, regarding a modification example of the light source module according to the fourth embodiment, a light source module enabling modulation of each of three beams of visible light having different wavelengths has been described. However, similarly in the electro-optical element according to the fifth embodiment and the light source module according to the sixth embodiment as well, the light source module enabling modulation of each of three different beams of visible light can be produced on the basis of the light source module enabling modulation of visible light having one wavelength.

FIG. 9B is a schematic plan view showing another modification example of a light source module according to the fourth embodiment. Hereinafter, illustration and description of parts common to those of the foregoing constitutions may be omitted. In the example shown in FIG. 9A, the electro-optical element 200 has a constitution including three light output ports for outputting three beams of visible light having different wavelengths to the outside, in which respective beams of visible light are output through three light output ports. Meanwhile, in the example shown in FIG. 9B, the electro-optical element 201 has a constitution including the coupling portion configured to couple three beams of visible light having different wavelengths and one light output port through which coupled light is output to the outside, in which three beams of visible light having different wavelengths are coupled and output. Hereinafter, a case in which three beams of visible light having different wavelengths are beams of visible light respectively output from three-color (RGB) visible laser light sources will be described as an example.

A light source module 500 shown in FIG. 9B includes the electro-optical element 201 shown in FIG. 5B; the red laser light source 30-1 which outputs red laser light input through the light input port 21-1i; the green laser light source 30-2 which outputs green laser light input through the light input port 21-2i; the blue laser light source 30-3 which outputs blue laser light input through the light input port 21-3i; and the laser light intensity control part 180 which can detect monitoring light from each of the monitoring light output port 41-mo, the monitoring light output port 42-mo, and the monitoring light output port 43-mo using the photodetector 170 and can independently adjust the intensities of respective beams of laser light emitted from the red laser light source 30-1, the green laser light source 30-2, and the blue laser light source 30-3 in accordance with the intensities of respective beams of detected laser light.

As above, the light source module 500 shown in FIG. 9B includes the electro-optical element 200 shown in FIG. 5B as the electro-optical element. In FIG. 9B, the constituent elements indicated by the reference signs used in FIG. 5B will be considered as common elements and description thereof will be omitted.

### [Optical Engine]

In this specification, an optical engine is a device including a plurality of light sources, an optical system which includes a coupling portion causing a plurality of beams of light emitted from the plurality of light sources to become one ray of light, an optical scanning mirror which reflects light emitted from the optical system by changing an angle so as to be displayed in an image, and a control element which controls the optical scanning mirror.

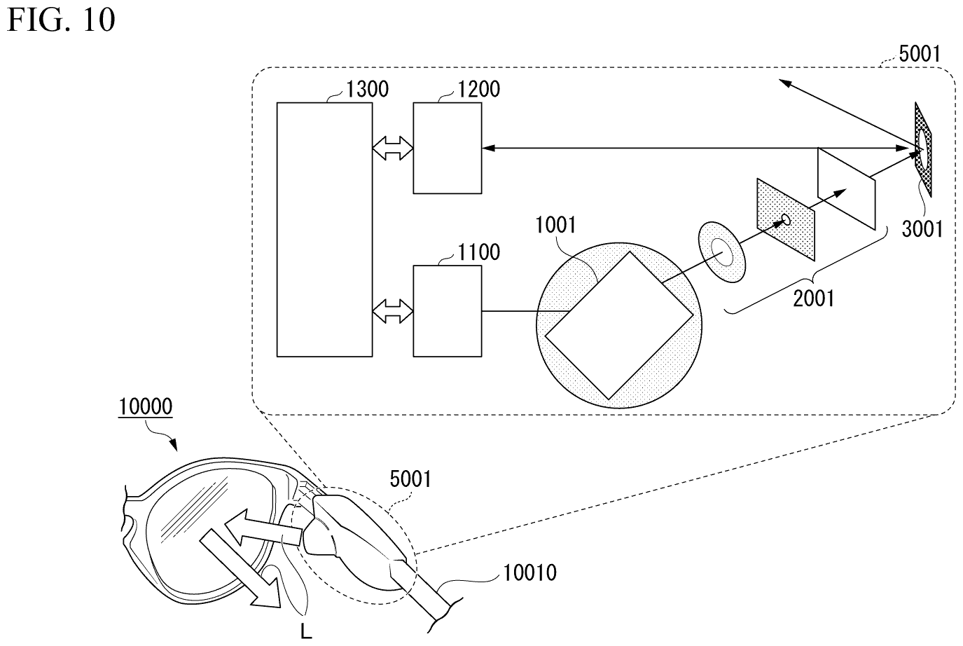

FIG. 10 shows an explanatory conceptual diagram of an optical engine 5001 according to the present embodiment. The diagram shows a state in which a frame 10010 of glasses is equipped with the optical engine 5001. The reference sign L indicates image display light.

The optical engine 5001 has a visible light source module 1001 and an optical scanning mirror 3001. The visible light source module according to the embodiments described above is used as the visible light source module 1001 provided in the optical engine 5001.

Irradiation laser light from the visible light source module 1001 attached to the glasses frame is reflected and scanned by the optical scanning mirror and enters the human eye so that an image (video image) is directly projected onto the retina.

For example, the optical scanning mirror 3001 is an MEMS mirror. In order to project a 2D image, it is preferable to adopt a two-axis MEMS mirror which vibrates so as to reflect laser light by changing the angle in the horizontal direction (X direction) and the vertical direction (Y direction).

The optical engine 5001 has a collimator lens 2001a, a slit 2001b, and an ND filter 2001c as an optical system for optically processing laser light emitted from the visible light source module 1001. This optical system is an example, and it may have a different constitution.

The optical engine 5001 has a laser driver 1100, an optical scanning mirror driver 1200, and a video controller 1300 which controls these drivers.

### [Xr Glasses]

In XR glasses according to the present embodiment, any of the light source modules according to the foregoing embodiments is mounted in glasses.

The XR glasses (spectacles) are a glasses-type terminal, and XR is a general term of virtual reality (VR), augmented reality (AR), and mixed reality (MR).

FIG. 10 shows an explanatory conceptual diagram of the XR glasses according to the present embodiment.

In XR glasses 10000 shown in FIG. 10, the visible light source module 1001 is mounted in the frame 10010. The reference sign L indicates image display light.

In FIG. 10, the visible light source module 1001, the optical scanning mirror 3001, and an optical system 2001 connecting the visible light source module 1001 and the optical scanning mirror 3001 to each other may be collectively referred to as the optical engine 5001. The visible light source module according to the embodiments described above is used as the visible light source module 1001.

Regarding the light source in the visible light source module 1001, for example, a light source having RGB laser light sources such as a red laser light source 60-1, a green laser light source 60-2, and a blue laser light source 60-3 can be used.

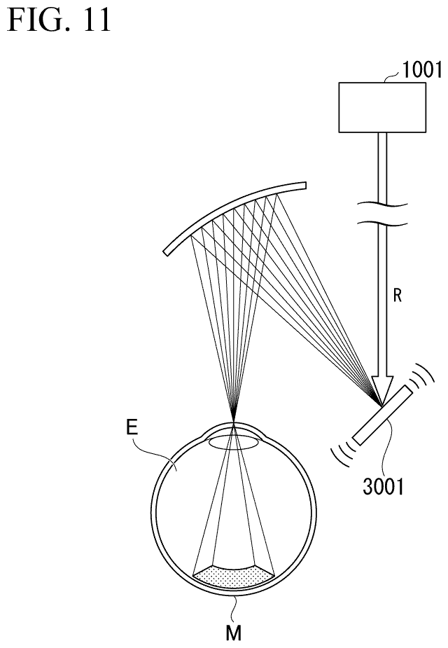

As shown in FIG. 11, irradiation laser light from the visible light source module 1001 attached to the glasses frame is reflected by the optical scanning mirror 3001 and enters a human eyeball E so that an image (video image) can be directly projected a retina M.

By providing an eye tracking mechanism, an image is directly projected onto the retina while eye tracking is performed. A known mechanism can be used as the eye tracking mechanism.

For example, the optical scanning mirror 3001 is an MEMS mirror. In order to project a 2D image, it is preferable to adopt a two-axis MEMS mirror which vibrates so as to reflect laser light by changing the angle in the horizontal direction (X direction) and the vertical direction (Y direction).

The optical system 2001 optically processing laser light emitted from the visible light source module 1001 has the collimator lens 2001a, the slit 2001b, and the ND filter 2001c. This optical system is an example, and it may have a different constitution.

The optical engine 5001 has a laser driver 1100, an optical scanning mirror driver 1200, and a video controller 1300 which controls these drivers.

### EXAMPLES

Hereinafter, the present disclosure will be described in more detail using Examples. However, the present disclosure is not limited to the following Examples in any way.

### Experimental Example 1

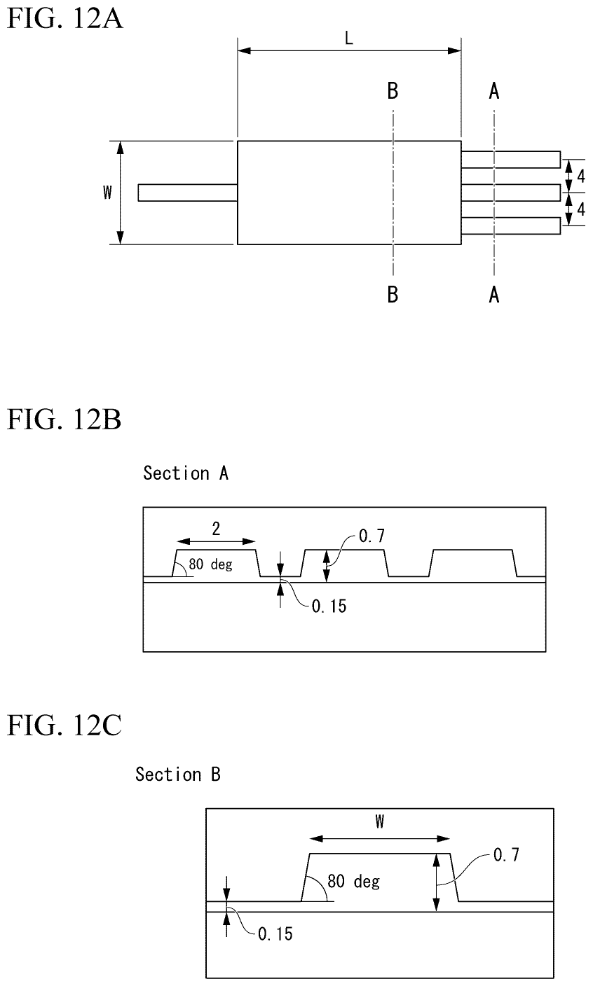

Regarding the one-input three-output type optical branching part shown in FIG. 1, through a simulation with the parameters shown in FIGS. 12A to 12C, for each of RGB, the efficiency (Pout/Pin) of the intensity of output light (Pout) with respect to the intensity of input light (Pin) and the ratio (Pmonitor/Pin) of the intensity of monitoring light with respect to the intensity of input light (Pin) were calculated. The intensity of output light was the sum of the intensities of light output from two optical modulation optical waveguides (corresponding to the reference signs 41-1 and 41-2 in FIG. 1), and the intensity of monitoring light was the intensity of light output from the optical waveguide for monitoring (corresponding to the reference sign 41-m in FIG. 1). Fimmwave (PHOTON Design Corporation) was used as simulation software. The RGB wavelengths were set to 637 nm, 520 nm, and 455 nm, respectively.

As shown in FIG. 12A, with the one-input three-output type optical branching part (corresponding to the reference sign 50-1 in FIG. 1) having a length of L and a width of W, the L and the W at which Pout/Pin and Pmonitor/Pin became approximately ⅔ and ⅓ respectively were determined by adjusting the L and the W.

FIG. 12B is a schematic cross-sectional view along line A-A in FIG. 12A, and FIG. 12C is a schematic cross-sectional view along line B-B in FIG. 12A.

Regarding materials, the substrate (corresponding to the reference sign 10 in FIG. 2) was made of sapphire, the waveguide core film (corresponding to the reference sign 24 in FIG. 2) was constituted of a lithium niobate film, and the waveguide cladding film (corresponding to the reference sign 25 in FIG. 2) was constituted of a SiO₂ film.

The shapes and the dimensions of the one-input three-output type optical branching part, the light input side optical waveguide (corresponding to the reference sign 21-1 in FIG. 1) connected to the one-input three-output type optical branching part, the optical waveguide for monitoring (corresponding to the reference sign 41-m in FIG. 1), and the optical modulation optical waveguide (corresponding to the reference signs 41-1 and 41-2 in FIG. 1) were set as shown in FIGS. 12A to 12C. Regarding the shapes, all the one-input three-output type optical branching part, the light input side optical waveguide, the optical waveguide for monitoring, and the optical modulation optical waveguide had trapezoidal cross sections and were constituted to have a slab with a thickness of 0.15 μm. The widths of upper bottoms of the light input side optical waveguide, the optical waveguide for monitoring, and the optical modulation optical waveguide were set to 2 μm, the angle of inclination of the side surface was set to 80°, and the thickness (height) from the main surface (corresponding to the reference sign 10A in FIG. 2) of the substrate 10 was set to 0.7 μm. The intervals between the optical waveguide for monitoring and the two optical modulation optical waveguides were set to 4 μm.

Table 1 shows obtained results of the length and the width of the one-input three-output type optical branching part, Pout/Pin, and Pmonitor/Pin.

TABLE 1

| Wavelength | Length L | Width W | Light output | Monitoring |
|---|---|---|---|---|
| (nm) | (μm) | (μm) | efficiency | light ratio |
| 637 | 169 | 12 | 0.66 | 0.33 |
| 520 | 212 | 12 | 0.66 | 0.33 |
| 455 | 246 | 12 | 0.66 | 0.33 |

As shown in Table 1, regarding any of RGB visible light, when the width W of the one-input three-output type optical branching part was 12 μm, the light output efficiency (Pout/Pin) and the monitoring light ratio (Pmonitor/Pin) could be set to 0.66 and 0.33 by setting the lengths L to 169 μm, 212 μm, and 246 μm, respectively. From the foregoing results, it was ascertained that Pout/Pin and Pmonitor/Pin could be set to approximately ⅔ and ⅓, respectively for any of RGB visible light using the electro-optical element shown in FIG. 5A.

### Experimental Example 2

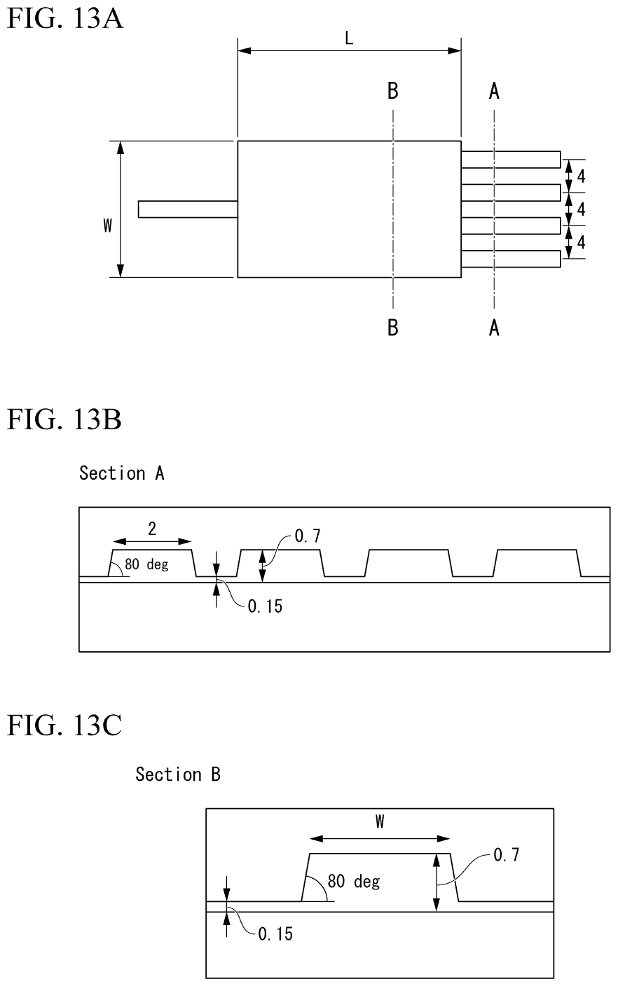

Regarding the one-input four-output type optical branching part shown in FIG. 3, through a simulation with the parameters shown in FIGS. 13A to 13C, for R, the efficiency (Pout/Pin) of the intensity of output light (Pout) with respect to the intensity of input light (Pin) and the ratio (Pmonitor/Pin) of the intensity of monitoring light with respect to the intensity of input light (Pin) were calculated.

As shown in FIG. 13A, with the one-input four-output type optical branching part (corresponding to the reference sign 150-1 in FIG. 3) having a length of L and a width of W, the L and the W at which Pout/Pin, and Pmonitor/Pin became approximately ¾ and ¼ respectively were determined by adjusting the L and the W.

FIG. 13B is a schematic cross-sectional view along line A-A in FIG. 13A, and FIG. 13C is a schematic cross-sectional view along line B-B in FIG. 13A.

The shapes and the dimensions of the one-input four-output type optical branching part, the light input side optical waveguide (corresponding to the reference sign 121-1 in FIG. 3) connected to the one-input four-output type optical branching part, the optical waveguide for monitoring (corresponding to the reference sign 141-m in FIG. 3), and the optical modulation optical waveguide (corresponding to the reference signs 141-1, 141-2, and 141-3 in FIG. 3) were set as shown in FIGS. 13A to 13C. Regarding the shapes, all the one-input four-output type optical branching part, the light input side optical waveguide, the optical waveguide for monitoring, and the optical modulation optical waveguide had trapezoidal cross sections and were constituted to have a slab with a thickness of 0.15 μm. The widths of the upper bottoms of the light input side optical waveguide, the optical waveguide for monitoring, and the optical modulation optical waveguide were set to 2 μm, the angle of inclination of the side surface was set to 80°, and the thickness (height) from the main surface (corresponding to the reference sign 10A in FIG. 2) of the substrate 10 was set to 0.7 μm. The intervals between the optical waveguide for monitoring and the three optical modulation optical waveguides were set to 4 μm.

Table 2 shows obtained results of the length and the width of the one-input four-output type optical branching part, Pout/Pin, and Pmonitor/Pin.

TABLE 2

| Wavelength | Length L | Width W | Light output | Monitoring |
|---|---|---|---|---|
| (nm) | (μm) | (μm) | efficiency | light ratio |
| 637 | 223 | 16 | 0.74 | 0.24 |

As shown in Table 2, regarding R, when the width W of the one-input four-output type optical branching part was 16 μm, the light output efficiency (Pout/Pin) and the monitoring light ratio (Pmonitor/Pin) could be set to 0.74 and 0.24 by setting the length L to 223 μm.

### Experimental Example 3

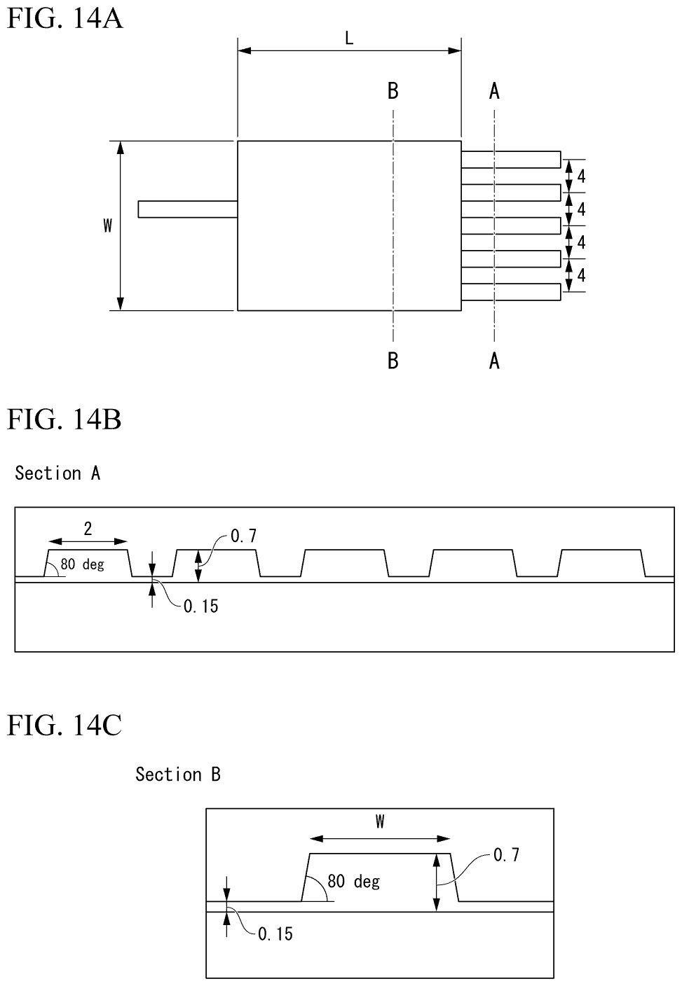

Regarding the one-input five-output type optical branching part shown in FIG. 4, through a simulation with the parameters shown in FIGS. 14A to 14C, for R, the efficiency (Pout/Pin) of the intensity of output light (Pout) with respect to the intensity of input light (Pin) and the ratio (Pmonitor/Pin) of the intensity of monitoring light with respect to the intensity of input light (Pin) were calculated.

As shown in FIG. 14A, with the one-input five-output type optical branching part (corresponding to the reference sign 250-1 in FIG. 4) having a length of L and a width of W, the L and the W at which Pout/Pin, and Pmonitor/Pin became approximately ¾ and ¼ respectively were determined by adjusting the L and the W.

FIG. 14B is a schematic cross-sectional view along line A-A in FIG. 14A, and FIG. 14C is a schematic cross-sectional view along line B-B in FIG. 14A.

The shapes and the dimensions of the one-input five-output type optical branching part, the light input side optical waveguide (corresponding to the reference sign 221-1 in FIG. 4) connected to the one-input five-output type optical branching part, the optical waveguide for monitoring (corresponding to the reference sign 41-m in FIG. 4), and the optical modulation optical waveguide (corresponding to the reference signs 241-11, 241-12, 241-21, and 241-22 in FIG. 4) were set as shown in FIGS. 14A to 14C. Regarding the shapes, all the one-input five-output type optical branching part, the light input side optical waveguide, the optical waveguide for monitoring, and the optical modulation optical waveguide had trapezoidal cross sections and were constituted to have a slab with a thickness of 0.15 μm. The widths of the upper bottoms of the light input side optical waveguide, the optical waveguide for monitoring, and the optical modulation optical waveguide were set to 2 μm, the angle of inclination of the side surface was set to 80°, and the thickness (height) from the main surface (corresponding to the reference sign 10A in FIG. 2) of the substrate 10 was set to 0.7 μm. The intervals between the optical waveguide for monitoring and the four optical modulation optical waveguides were set to 4 μm.

Table 3 shows obtained results of the length and the width of the one-input five-output type optical branching part, Pout/Pin, and Pmonitor/Pin.

TABLE 3

| Wavelength | Length L | Width W | Light output | Monitoring |
|---|---|---|---|---|
| (nm) | (μm) | (μm) | efficiency | light ratio |
| 637 | 278 | 20 | 0.79 | 0.19 |

As shown in Table 3, regarding R, when the width W of the one-input five-output type optical branching part was 20 μm, the light output efficiency (Pout/Pin) and the monitoring light ratio (Pmonitor/Pin) could be set to 0.79 and 0.19 by setting the length L to 278 μm.

### EXPLANATION OF REFERENCES

10 Substrate
20 Optical function layer
30 Visible laser light source
40 Mach-Zehnder optical modulation part
50-1, 150-1, 250-1 Optical branching part
150-2, 250-2 Optical coupling/branching part
50-2, 150-3, 250-3 Optical coupling part
100, 101, 102, 200 Electro-optical element
300, 301, 302, 400, 1001 Light source module
5001 Optical engine 10
10000 XR glasses

What is claimed is:

1. An electro-optical element comprising:
a substrate; and
an optical function layer configured to be formed on a main surface of the substrate,
wherein the optical function layer has
a light input port configured to allow visible light emitted from a visible laser light source to be input therethrough,
an optical branching part in which a light input side optical waveguide guiding visible light input through the light input port is connected to one optical waveguide for monitoring and a plurality of optical modulation optical waveguides,
a Mach-Zehnder optical modulation part configured to modulate visible light guided by the plurality of optical modulation optical waveguides,
an optical coupling part configured to couple two beams of visible light modulated by the Mach-Zehnder optical modulation part,
a light output side waveguide configured to guide light coupled by the optical coupling part to a light output port,
the light output port through which light guided by the light output side waveguide is output to the outside, and
a monitoring light output port through which light guided by the optical waveguide for monitoring is output toward a photodetector.

2. The electro-optical element according to claim 1,
wherein the plurality of optical modulation optical waveguides are two optical modulation optical waveguides.

3. The electro-optical element according to claim 2,
wherein the substrate is made of a material different from lithium niobate, and the optical function layer is made of lithium niobate.

4. The electro-optical element according to claim 3,
wherein both the optical branching part and the optical coupling part constitute a multimode interferometer.

5. The electro-optical element according to claim 4 further comprising:
three light input ports configured to allow three beams of visible light having different wavelengths and respectively output from three visible laser light sources to be input therethrough; and
three light output ports configured to output three beams of visible light having different wavelengths to the outside.

6. The electro-optical element according to claim 4 further comprising:
three light input ports configured to allow three beams of visible light having different wavelengths and respectively output from three visible laser light sources to be input therethrough;
an optical coupling part configured to couple three beams of visible light having different wavelengths; and
one light output port configured to output light coupled by the optical coupling part to the outside.

7. The electro-optical element according to claim 1,
wherein the plurality of optical modulation optical waveguides are (N₁−1) (N₁ is an integer equal to or larger than 3) optical modulation optical waveguides, and
a (N₁−1)×2 type optical coupling/branching part, in which the (N₁−1) optical modulation optical waveguides are connected to an incidence side and two optical waveguides connected to the Mach-Zehnder optical modulation part are connected to an emission side, is provided between the optical branching part and the Mach-Zehnder optical modulation part.

8. The electro-optical element according to claim 7,
wherein the substrate is made of a material different from lithium niobate, and the optical function layer is made of lithium niobate.

9. The electro-optical element according to claim 8,
wherein both the optical branching part and the optical coupling part constitute a multimode interferometer.

10. The electro-optical element according to claim 9 further comprising:
three light input ports configured to allow three beams of visible light having different wavelengths and respectively output from three visible laser light sources to be input therethrough; and
three light output ports configured to output three beams of visible light having different wavelengths to the outside.

11. The electro-optical element according to claim 9 further comprising:
three light input ports configured to allow three beams of visible light having different wavelengths and respectively output from three visible laser light sources to be input therethrough;
an optical coupling part configured to couple three beams of visible light having different wavelengths; and
one light output port configured to output light coupled by the optical coupling part to the outside.

12. The electro-optical element according to claim 1,
wherein the plurality of optical modulation optical waveguides are 2N₂ (N₂ is an integer equal to or larger than 2) optical modulation optical waveguides,
two N₂×1 type optical branching parts are provided between the optical branching part and the Mach-Zehnder optical modulation part, and
in each of the two N₂×1 type optical branching parts, N₂ optical modulation optical waveguides of the 2N₂ optical modulation optical waveguides are connected to an incidence side, and one optical waveguide connected to the Mach-Zehnder optical modulation part is connected to an emission side.

13. The electro-optical element according to claim 12,
wherein the substrate is made of a material different from lithium niobate, and the optical function layer is made of lithium niobate.

14. The electro-optical element according to claim 13,
wherein both the optical branching part and the optical coupling part constitute a multimode interferometer.

15. The electro-optical element according to claim 14 further comprising:
three light input ports configured to allow three beams of visible light having different wavelengths and respectively output from three visible laser light sources to be input therethrough; and
three light output ports configured to output three beams of visible light having different wavelengths to the outside.

16. The electro-optical element according to claim 14 further comprising:
three light input ports configured to allow three beams of visible light having different wavelengths and respectively output from three visible laser light sources to be input therethrough;
an optical coupling part configured to couple three beams of visible light having different wavelengths; and
one light output port configured to output light coupled by the optical coupling part to the outside.

17. A light source module comprising:
the electro-optical element according to claim 1
a visible laser light source configured to output visible light input through the light input port; and
a laser light intensity control part configured to detect monitoring light from the monitoring light output port using a photodetector and adjust an intensity of laser light emitted from the visible laser light source in accordance with an intensity of detected light.

18. An optical engine comprising:
the light source module according to claim 17 configured to be mounted therein.

19. XR glasses comprising:
the light source module according to claim 17 configured to be mounted therein.
